(19) United States
(12) Patent Application Publication
(10) Pub. No.: US 2014/0025782 A1
(43) Pub. Date: Jan. 23, 2014

(54) SYSTEM AND METHOD FOR PLAYING AND TRANSMITTING NETWORK VIDEO

(71) Applicant: Hon Hai Precision Industry Co., Ltd., New Taipei (TW)

(72) Inventors: PO-HUI LU, New Taipei (TW); CHUN-NAN YU, New Taipei (TW)

(21) Appl. No.: 13/904,162

(22) Filed: May 29, 2013

(30) Foreign Application Priority Data
Jul. 18, 2012 (TW) 101125782

(51) Int. Cl. H04L 29/06

(52) U.S. Cl. CPC H04L 29/06476
USPC 709/219

(57) ABSTRACT

A method of playing a network video using an electronic device includes acquiring a web address of the network video from a browser, and transmitting the acquired web address to the web server. When the browser does not support a Motion Joint Photographic Experts Group (MJPEG) format, a static image frame is established. The method further transmits the acquired web address to the web server and requesting a transmission of each single static image from the web server. The method further receives each single static image from the web server and generates a video file comprising a plurality of single static images by adding the received each single static image into the established static image frame. The method further displays the single static images successively in the browser to play the network video.

### BACKGROUND

1. Technical Field

Embodiments of the present disclosure relate to video management technology, and particularly to a system and a method for playing and transmitting network videos using an electronic device and a web server.

2. Description of Related Art

An Internet Protocol (IP) camera may include functions of a camera and a computer. The IP camera can capture videos and transmit these videos through a local area network, the Internet, or a wireless network. However, if the videos generated by the IP camera are played in an electronic device (e.g. a personal computer, a mobile phone or a panel computer), specific video playing software (e.g. media player software or television software) is required to be used. Therefore, different kinds of video playing software need to be developed and tested for different kinds of electronic devices, which is inconvenient.

### BRIEF DESCRIPTION OF THE DRAWINGS

FIG. 1 is a schematic diagram of one embodiment of an electronic device and a web server.

FIG. 2 is a block diagram of one embodiment of an electronic device including a video playing system and a web server including a video transmission system.

FIG. 3 is a block diagram of one embodiment of function modules of the video playing system in FIG. 2.

FIG. 4 is a block diagram of one embodiment of function modules of the video transmission system in FIG. 2.

FIG. 5 is a flowchart illustrating one embodiment of a method for playing network videos.

FIG. 6 is a first partial flowchart illustrating one embodiment of the method for playing network videos of FIG. 5.

FIG. 7 is a second partial flowchart illustrating one embodiment of the method for playing network videos of FIG. 5.

FIG. 8 is a flowchart illustrating one embodiment of a method for transmitting the network videos.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

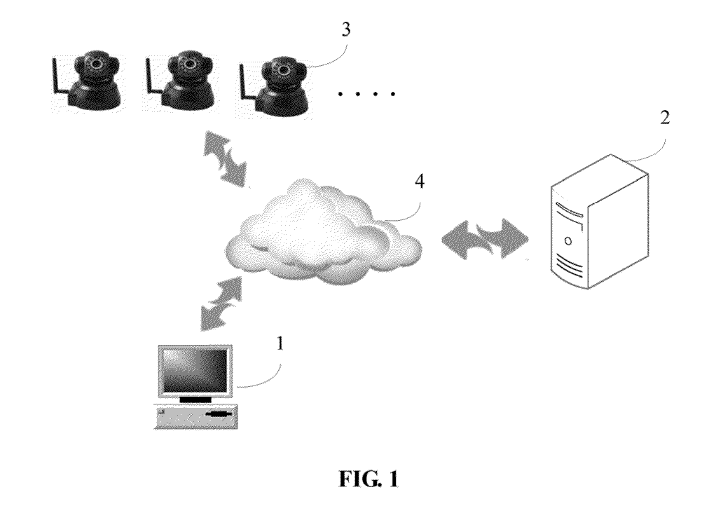

FIG. 1 is a schematic diagram of one embodiment of an electronic device 1 and a web server 2. The electronic device 1, the web server 2 and a plurality of Internet Protocol (IP) cameras 3 communicate with each other through a network 4 (e.g. the Internet or an intranet). The electronic device 1 may be a computer device, a mobile phone, or a tablet computer, that can connect to the network 4 and browse web pages. The IP cameras 3 provide video sources. In other embodiments, the IP cameras 3 can be replaced by other devices that provide video sources. The web server 2 provides services of delivering web content (e.g. web pages).

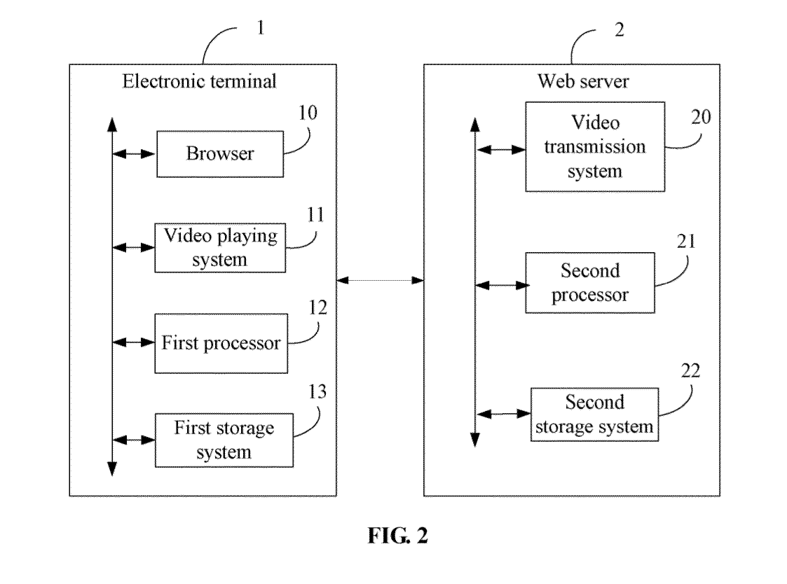

FIG. 2 is a block diagram of one embodiment of the electronic device 1 including a video playing system 11 and the web server 2 including a video transmission system 20. The electronic device 1 further includes a browser 10, a first processor 12, and a first storage system 13. The web server 2 further includes a second processor 21 and a second storage system 22. The browser 10 may be an Internet Explorer™ (IE) browser, a Mozilla Firefox™ browser, a Google Chrome™ browser, or other web browser installed in the electronic device 1. The video playing system 11 may request a network video from the web server 2 according to a web address of the network video, and receive the network video from the web server 2, and output the received network video. The video transmission system 20 may obtain the network video according to the web address and transmit the network video to the electronic device 1.

The first storage system 13 and the second storage system 22 may be memories, or external storage cards, such as a smart media card, or a secure digital card. The first processor 12 executes one or more computerized codes and other applications for the electronic device 1, to provide the functions of the video playing system 11. The second processor 21 executes one or more computerized codes and other applications for the web server 2, to provide the functions of the video transmission system 20.

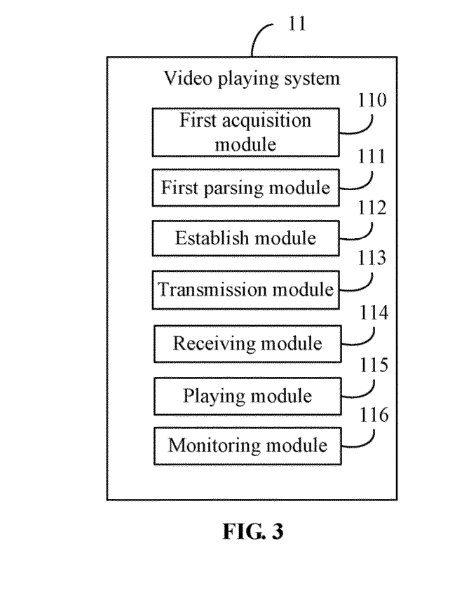

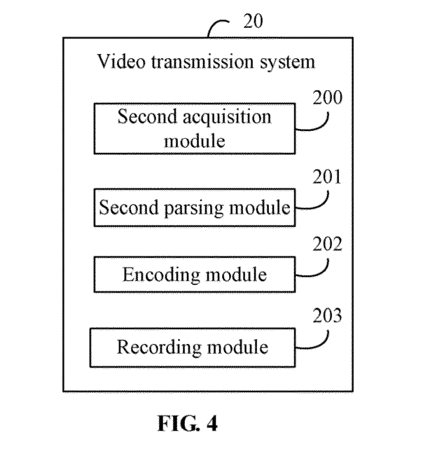

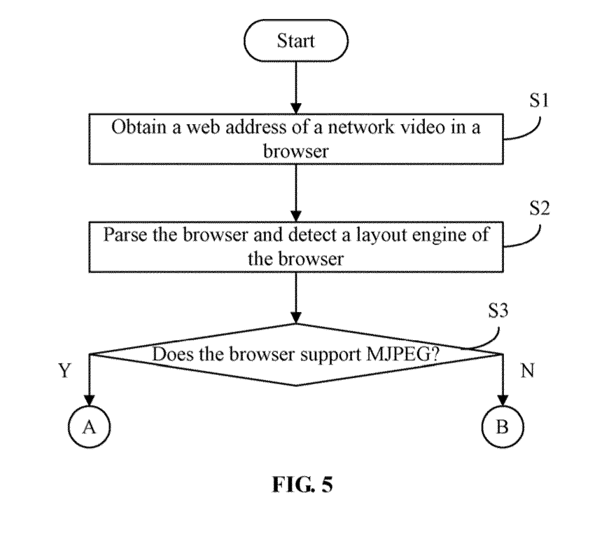

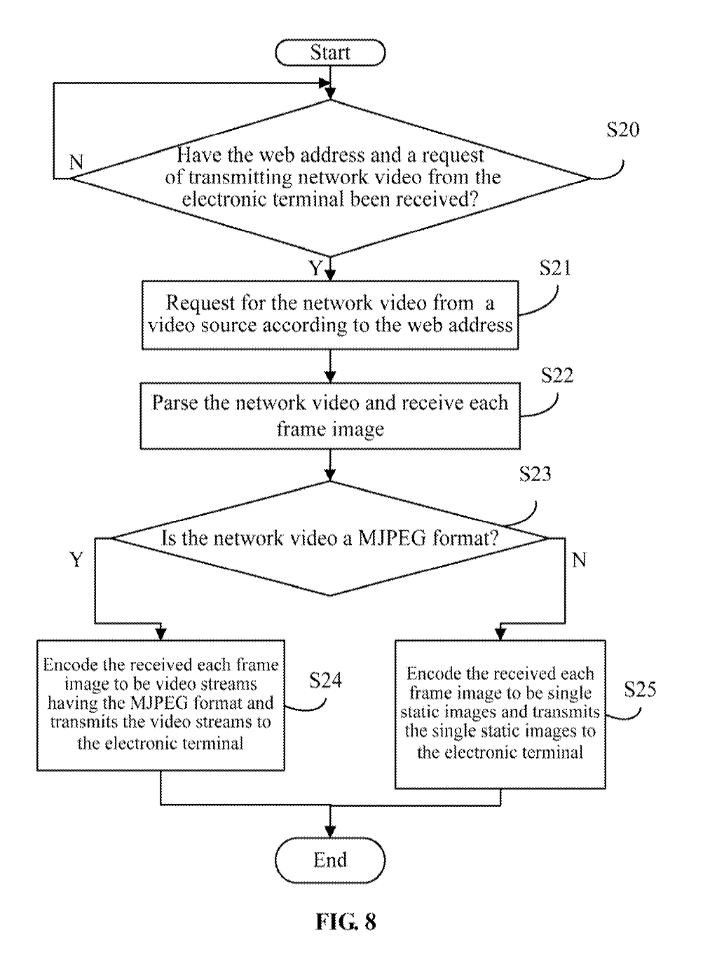

As shown in FIG. 3, the video playing system 11 includes a first acquisition module 110, a first parsing module 111, an establishment module 112, a transmission 113, a receiving module 114, a playing module 115 and a monitoring module 116. The one or more modules may comprise computerized instructions in the form of one or more programs that are stored in the first storage system 13 and executed by the first processor 12 to provide functions of the modules 110-116. Details of each of the modules are given in FIG. 5-7. As shown in FIG. 4, the video transmission system 20 includes a second acquisition module 200, a second parsing module 201, an encoding module 202 and a recording module 203. The one or more modules may comprise computerized instructions in the form of one or more programs that are stored in the second storage system 22 and executed by the second processor 21 to provide functions of the modules 200-203. Details of each of the modules are given in FIG. 8.

FIG. 5-FIG. 7 are flowcharts illustrating one embodiment of a method for playing network videos. Depending on the embodiment, additional steps may be added, others deleted, and the ordering of the steps may be changed.

In step S1, the first acquisition module 110 acquires a web address of the network video in an address column of the browser 10. The web address is an address of a video source.

In step S2, the first parsing module 111 parses the browser 10 and detects a layout engine of the browser 10. The first parsing module 111 detects the layout engine according to JavaScript of the browser 10. For example, if the browser 10 is the IE browser 10, the first parsing module 111 detects that the layout engine of the browser 10 uses the Trident layout engine.

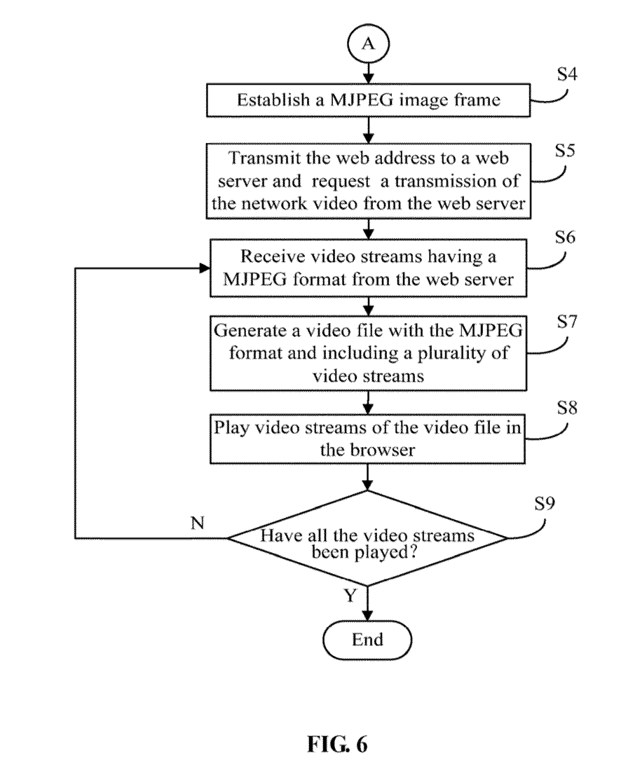

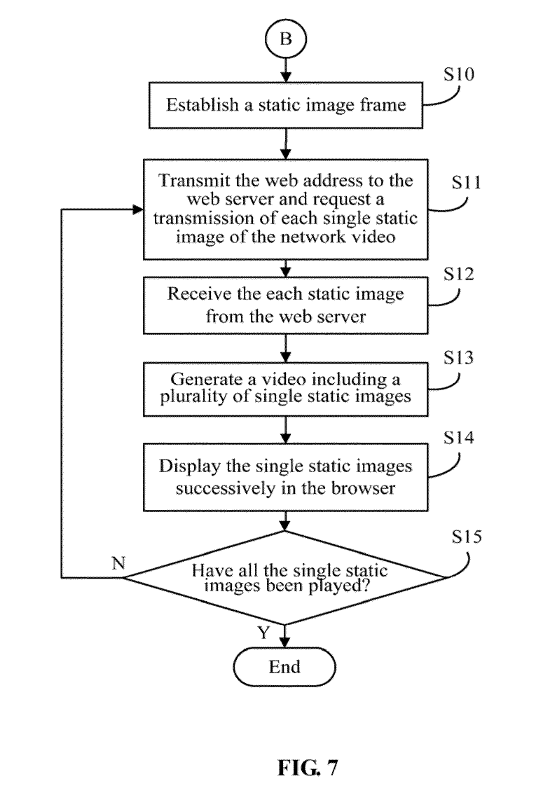

In step S3, the first parsing module 111 determines whether the browser 10 supports a Motion Joint Photographic Experts Group (MJPEG) format according to the layout engine of the browser 10. In some embodiments, some layout engines support the MJPEG format, such as the Gecko layout engine and the Webkit layout engine, and some layout engines do not support the MJPEG format, for example the Trident layout engine. If the browser 10 supports the MJPEG format, FIG. 6 is implemented. If the browser 10 does not support the MJPEG format, FIG. 7 is implemented.

As shown in FIG. 6, when the browser 10 does support the MJPEG format, then in step S4, the establishment module 112 establishes a MJPEG image frame. The image frame is a widget that can be added video data (e.g. video streams or single static images) to form a video file, and the image frame can be established in a window in the browser 10 to play the formed video file. The MJPEG image frame can be added video streams to form the video file having the MJPEG format.

In step S5, the transmission module 113 transmits the acquired web address from the browser 10 to the web server 2, and requests the transmission of the network video from the web server 2.

In step S6, the receiving module 114 receives video streams having the MJPEG format of the network video.

In step S7, the playing module 115 generates a video file having the MJPEG format and including a by adding the received video streams into the established MJPEG image frame.

In step S8, the playing module 115 plays the plurality of video streams of the video file in the browser 10.

In one embodiment, the video streams having the MJPEG format includes a sequence of images, step S6 to step S8 are executed repeatedly until all of the video streams of the network video have been played. In step S9, the playing module 115 determines whether all of the video streams of the network video have been played. If there is one video stream of the network video that has not been played, step S6 is repeated. If all of the video streams of the network video have been played, the procedure ends.

During step S5 to step S8, the monitoring module 116 monitors a connection status of the network 4 in real-time, and determines whether the network 4 is disconnected. The monitoring module 116 determines a disconnection of the network 4 according to a connection record table recorded in the web server 2. When the network 4 is disconnected, the monitoring module 114 reconnects to the network 4 automatically, until all the video streams of the network video have been played.

As shown in FIG. 7, when the browser 10 does not support the MJPEG format, in step S10, the establishment module 112 establishes a static image frame. The static image frame can be added single static images to form the video file.

In step S11, the transmission module 113 transmits the acquired web address from the browser 10 to the web server 2, and requests the transmission of each single static image of the network video from the web server 2.

In step S12, the receiving module 114 receives each single static image from the web server 2.

In step S13, the playing module 115 generates a video file including a plurality of single static images by adding the received each single static image successively into the established static image frame.

In step S14, the playing module 115 displays the plurality of single static images successively of the video file in the browser 10.

If the received single static images do not form a completed and integrated video file, that is, the whole network video has not finished playing, step S11 to step S14 are executed repeatedly until all of the single static images of the network video are received to be displayed. In step S15, the playing module 115 determines whether all of the single static images of the network video have been played. If there is a single static image of the network video which has not been played, step S11 is repeated. If all of the single static images comprising the network video have been played, the procedure ends.

During step S11 to step S14, the monitoring module 116 monitors the connection status of the network 4 in real-time, and determines whether the network 4 is disconnected. The monitoring module 116 determines the disconnection of the network 4 according to the connection record table in the web server 2. When the network 4 is disconnected, the monitoring module 114 reconnects to the network 4 automatically, until all of the single static images of the network video have been received and played.

FIG. 8 is a flowchart illustrating one embodiment of a method for transmitting network videos. Depending on the embodiment, additional steps may be added, others deleted, and the ordering of the steps may be changed.

In step S20, the second acquisition module 200 receives the web address and a request from the electronic device 1, such as the request to transmit the network video or each single static image of the network video, for example.

In step S21, the second parsing module 201 requests the network video from the video source (e.g. one of the IP cameras 3) corresponding to the received web address.

In step S22, the second parsing module 201 parses the network video obtained from the video source, and receives each frame image of the network video. In one embodiment, the second parsing module 201 decomposes the network video into separate frame images by decoding the network video using a predetermined decoder applicable to the network video.

In step S23, the encoding module 202 determines whether the network video is the MJPEG format. If the network video is the MJPEG format, step 24 is implemented. If the network video is not the MJPEG format, step S25 is implemented.

In step S24, the encoding module 202 encodes the received frame images into MJPEG format video streams, and transmits the video streams to the electronic device 1.

In step S25, the encoding module 202 encodes each of the received frame images as the plurality of single static images as mentioned above, and transmits the plurality of single static images to the electronic device 1. During step S22 to step S25, the recording module 203 records a connection status of the network between the electronic device 1 and the web server 2 when receiving each frame image from the video source, into the connection record table.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method executable by a processor of an electronic device for playing a network video, comprising:
(a) acquiring a web address of the network video from a browser of the electronic device, and transmitting the acquired web address to a web server in communication with the electronic device through a network;
(b) establishing a static image frame when the browser does not support a Motion Joint Photographic Experts Group (MJPEG) format;
(c) transmitting the acquired web address to the web server and requesting a transmission of each single static image of the network video from the web server;
(d) receiving the transmission of each single static image from the web server;
(e) generating a video file comprising a plurality of single static images by adding the received each single static image into the established static image frame successively, and displaying the plurality of single static images of the video file successively in the browser to play the network video;
(f) repeating step (c) to step (e) until all of the plurality of single static images have been played.

2. The method as described in claim 1, further comprising:
(g) establishing a MJPEG image frame when the browser supports the MJPEG format;
(h) transmitting the acquired web address to the web server, and requesting a transmission of the network video from the web server;
(i) receiving video streams having the MJPEG format of the network video from the web server;
(j) generating a video file having the MJPEG format and comprising a plurality of video streams by adding the received video streams into the established MJPEG image frame, and playing the plurality of the video streams of the video file in the browser;
(k) repeating step (i) to step (j) until all the video streams have been played.

3. The method as claimed in claim 2, further comprising:
monitoring a connection status of the network between the electronic device and the web server, and reconnecting the network when the network is disconnected.

4. The method as claimed in claim 1, further comprising:
detecting a layout engine of the browser and determining whether the browser supports the MJPEG format according to the layout engine of the browser.

5. The method as claimed in claim 1, wherein the network video is received from the web server by:
requesting the network video from a video source corresponding to the received web address;
parsing the network video obtained from the video source and receiving transmission of each frame image of the network video;
determining whether the network video is the MJPEG format;
when the network video is the MJPEG format, encoding the received each frame images to be video streams having the MJPEG format, and transmitting the video streams to the electronic device; or
when the network video is not the MJPEG format, encoding the received each frame image to be the plurality of single static images, and transmitting the plurality of single static images to the electronic device.

6. The method as claimed in claim 5, further comprising:
recording a connection status of the electronic device by the web server when the web server receives each frame image from the video source into a connection record table.

7. An electronic device, comprising:
a first storage system;
a first processor to executing one or more programs stored in the first storage system for performing a method of playing a network video, the method comprising:
(a) acquiring a web address of the network video from a browser of the electronic device, and transmitting the acquired web address to a web server in communication with the electronic device through a network;
(b) establishing a static image frame, when the browser does not support a Motion Joint Photographic Experts Group (MJPEG) format;
(c) transmitting the acquired web address to the web server and requesting a transmission of each single static image of the network video from the web server;
(d) receiving the transmission of each single static image from the web server;
(e) generating a video file comprising a plurality of single static images by adding the received each single static image into the established static image frame successively, and displaying the plurality of single static images of the video file successively in the browser to play the network video;
(f) repeating step (c) to step (e) until the all the single static images have been played.

8. The electronic device as described in claim 7, further comprising:
(g). establishing a MJPEG image frame when the browser supports the MJPEG format;
(h). transmitting the acquired web address to the web server, and requesting a transmission of the network video from the web server;
(i). receiving video streams having the MJPEG format of the network video from the web server;
(j). generating a video file having the MJPEG format and comprising a plurality of video streams by adding the received video streams into the established MJPEG image frame, and playing the plurality of video streams of the video file in the browser;
(k) repeating step (i) to step (j) until all the video streams have been played.

9. The electronic device as described in claim 8, further comprising:
monitoring a connection status of the network between the electronic device and the web server, and reconnecting the network when the network is disconnected.

10. The electronic device as described in claim 7, further comprising:
detecting a layout engine of the browser and determining whether the browser support the MJPEG format according to the layout engine of the browser.

11. A web server, comprising:
a second storage system;
a second processor to executing one or more programs stored in the second storage system for performing a method of transmitting a network video, the method comprising:
receiving a web address of the network video from an electronic device communication with the web server through a network;
requesting the network video from a video source corresponding to the received web address;
parsing the network video obtained from the video source and receiving a transmission of each frame image of the network video;
determining whether the network video is Motion Joint Photographic Experts Group (MJPEG) format;
when the network video is the MJPEG format, encoding the received each frame image to be video streams having the MJPEG format, and transmitting the video streams to the electronic device; or
when the network video is not the MJPEG format, encoding the received each frame image to be single static images, and transmitting the single static images to the electronic device.

12. The web server as claimed in claim 11, wherein the web server further records a connection status of when receiving each frame image from the video source into a connection record table.
